(19) United States
(12) Patent Application Publication
(10) Pub. No.: US 2020/0412173 A1
(43) Pub. Date: Dec. 31, 2020

(54) WIRELESS WI-FI ELECTRONIC CHARGING DEVICE

(71) Applicant: James Odell York, JR., North Charleston, SC (US)

(72) Inventor: James Odell York, JR., North Charleston, SC (US)

(21) Appl. No.: 16/913,917

(22) Filed: Jun. 26, 2020

Related U.S. Application Data
(60) Provisional application No. 62/867,724, filed on Jun. 27, 2019.

(51) Int. Cl. H02J 50/20; H02J 50/00; H02J 7/00

(52) U.S. Cl. CPC H02J 50/20; H02J 7/0045; H02J 50/005

(57) ABSTRACT

The presently claimed invention relates to a wireless Wi-Fi electronic charging device that provides electronic devices with a wireless charging system designed to charge the device via Wi-Fi. The presently claimed invention enables users to connect to any Wi-Fi connection and thereby charge the battery of their electronic devices without a cord, even when a wall outlet and charger system are unavailable. The wireless Wi-Fi electronic charging device as claimed mimics the guidelines and structure of Wi-Fi.

### CROSS-REFERENCE TO RELATED APPLICATION

The present application is related to and claims priority from prior provisional application Ser. No. 62/867,724, filed Jun. 27, 2019 which application is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of electronic charging devices. More specifically, the invention is a wireless electronic charging device that charges devices via Wi-Fi.

### 2. Description of the Related Art

Charging electronic devices via a wall outlet and a corded charger can be frustrating. Without an outlet, devices are unable to charge. Losing battery power for a smartphone while away from home can lead to missed important calls, texts, emails, and the like.

The presently claimed invention relates to a wireless Wi-Fi electronic charging device that provides electronic devices with a wireless charging system designed to charge the device via Wi-Fi. The presently claimed invention enables users to connect to any Wi-Fi connection and thereby charge the battery of their electronic devices without a cord, even when a wall outlet and charger system are unavailable.

Ideally, a wireless Wi-Fi electronic charging device should provide a way of charging small electronic devices over Wi-Fi and, yet would operate reliably and be manufactured at a modest expense. Thus, a need exists for a reliable wireless Wi-Fi electronic charging device to avoid the above-mentioned problems.

### BRIEF SUMMARY OF THE INVENTION

In view of the foregoing disadvantages inherent in the known wireless charging art, the present invention provides a novel wireless charging devices that uses Wi-Fi to deliver the electric charge. The general purpose of the present invention, which will be described subsequently in greater detail is to provide a wireless Wi-Fi electronic charging device.

Devices are charged via Wi-Fi connection. Any Wi-Fi connection can be used to charge the device, thereby enabling users to charge phones without an outlet and corded charger system. The wireless charging system as claimed mimics the guidelines and structure of Wi-Fi.

The present invention holds significant improvements and serves as a wireless Wi-Fi electronic charging device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The FIGURES that accompany the written portion of this specification illustrate embodiments and method(s) of use for the present invention, a wireless Wi-Fi electronic charging device, constructed and operative according to the teachings of the present invention.

FIG. 1 shows a perspective view illustrating a wireless Wi-Fi electronic charging device according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to a wireless charging device and more particularly to a wireless Wi-Fi electronic charging device as used to improve the availability of charging the battery of a small electronic device even when no outlet is available.

Generally speaking, the wireless Wi-Fi electronic charging device as claimed mimics the guidelines and structure of Wi-Fi.

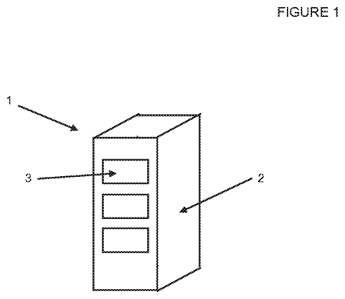

Referring to the drawings by numerals of reference there is shown in FIG. 1, a wireless Wi-Fi electronic charging device 1 with an outer housing 2 that contains the Wi-Fi charging apparatus. The outer housing 2 has at least one vent 3 to provide air to the Wi-Fi charging apparatus. The Wi-Fi charging apparatus emits a Wi-Fi signal capable of providing an electrical charge to the battery of a small electronic device, such as a smart phone or tablet.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A wireless Wi-Fi electronic charging device system comprising:
a. A Wi-Fi signal device, wherein the Wi-Fi signal devices emits a Wi-Fi signal that is capable of providing a wireless electric charge to a battery of a small electronic device;
b. an outer housing, wherein the Wi-Fi signal device is housed within the outer housing; and
c. at least one vent in a side of the outer housing, wherein the at least one vent provides air flow to the Wi-Fi signal device.
